(19) United States
(12) Patent Application Publication
(10) Pub. No.: US 2013/0111244 A1
(43) Pub. Date: May 2, 2013

(54) ELECTRIC APPARATUS AND ELECTRIC POWER SUPPLY CONTROL METHOD OF THE SAME

(71) Applicant: CANON KABUSHIKI KAISHA, Tokyo (JP)

(72) Inventor: So Yokomizo, Tokyo (JP)

(73) Assignee: CANON KABUSHIKI KAISHA, Tokyo (JP)

(21) Appl. No.: 13/649,168

(22) Filed: Oct. 11, 2012

(30) Foreign Application Priority Data
Oct. 26, 2011 (JP) 2011-235308

(51) Int. Cl. G06F 1/26

(52) U.S. Cl. 713/323

(57) ABSTRACT

When restarting is instructed, the power control state of an electric apparatus is stored in a non-volatile manner before starting shutdown processing, and the stored power control state is read after the restarting is initiated after the completion of the shutdown processing. When the read power control state is a power saving state, the state of the electric apparatus transitions to the power saving state.

### BACKGROUND OF THE INVENTION

1. Field of the Invention

The present invention relates to an electric apparatus that includes a power saving function for reducing power consumption and an electric power supply control method of the same.

2. Description of the Related Art

In a multi-function peripheral (MFP) provided with functions as a copier, printer, facsimile machine and the like, when the functions are not used for a certain period of time, the apparatus is set to the power saving mode to reduce power consumption. Meanwhile, it is required that these functions are operable at any time and the apparatus operates stably even if it is powered up for a long period of time. However, an apparatus may be sometimes left in an inoperable state due to a memory leak or the like. Therefore, an apparatus which is operable at any time is desirably restarted periodically to initialize the states of memories and various devices for refreshment. For example, Japanese Patent Laid-Open No. 2000-324283 proposes automatically performing regular rebooting without requiring manpower by automatically restarting the functions of the apparatus at a pre-set reset time by an auto reset function using a timer or the like.

When the apparatus is restarted, the states of memories and various devices are initialized, and therefore the apparatus is put in the standby state after the restart, regardless of the power control state of the apparatus before the restart. For example, when the power control state before the restarting is the standby state, the power control state is not changed even after restarting. However, when the power control state before restarting is a power saving state, the apparatus is put in the standby state when the apparatus is restarted, and therefore unnecessary power consumption occurs.

### SUMMARY OF THE INVENTION

An aspect of the present invention is to eliminate the above-mentioned problems with the conventional technology.

A feature of the present invention is to provide a technique for, when restarting is instructed, efficiently perform power saving control by setting the power control state so as to be the same as that before restarting.

According to an aspect of the present invention, there is provided an electric apparatus provided with a power saving function, comprising: a storage unit configured to, when restarting is instructed, store in a non-volatile manner the power control state of the electric apparatus before shutdown processing is started; a reading unit configured to read the power control state stored in the storage unit after the restarting is initiated after completion of the shutdown processing; a first transition unit configured to, when the power control state read by the reading unit is a power saving state, transition the electric apparatus to the power saving state; and a second transition unit that, when the power control state read by the reading unit is not the power saving state, or when the power control state is not stored in the storage unit, transition the electric apparatus to a standby state.

Further features and aspects of the present invention will become apparent from the following description of exemplary embodiments, with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram for describing the configuration of a multi-function peripheral (MFP) according to an embodiment.

FIG. 2 is a block diagram for describing the configuration of a control unit according to the embodiment.

FIG. 3 depicts a view illustrating power control states of the multi-function peripheral according to the embodiment.

FIG. 4 is a flowchart for describing shutdown processing in the multi-function peripheral according to the embodiment.

FIGS. 5A and 5B are flowcharts for describing the processing performed on startup in the multi-function peripheral according to the embodiment.

FIG. 6A is a flowchart for describing the processing performed when restarting is instructed in a sleep 1 state.

FIG. 6B depicts a graph which schematically represents the changes in the power consumption in the case of FIG. 6A.

FIG. 6C is a flowchart for describing the processing performed when restarting is instructed in a sleep 2 state.

FIG. 6D depicts a graph which schematically represents the changes in power consumption in the case of FIG. 6C.

FIG. 7A is a flowchart for describing the processing performed when restarting is instructed in a sleep 1 state.

FIG. 7B depicts a graph which schematically represents the changes in the power consumption in the case of FIG. 7A.

FIG. 7C is a flowchart for describing the processing performed when restarting is instructed in a sleep 2 state.

FIG. 7D depicts a graph which schematically represents the changes in power consumption in the case of FIG. 7C.

FIG. 8A is a flowchart for describing the processing performed when restarting is performed at a designated time in a multi-function peripheral according to the embodiment.

FIG. 8B is a flowchart for describing the processing performed when restarting is instructed by the operation of a switch by a user.

FIG. 9 is a flowchart for describing the processing performed when restarting is performed at the end of a specific job.

FIG. 10 is a flowchart for describing processing performed by a restart instruction after the specific job has been executed.

### DESCRIPTION OF THE EMBODIMENTS

Embodiments of the present invention will be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

It should be noted that in the embodiments, a multi-function peripheral will be described as an example of an electric apparatus that includes a power saving function according to the present invention, but the present invention is not limited to such an apparatus.

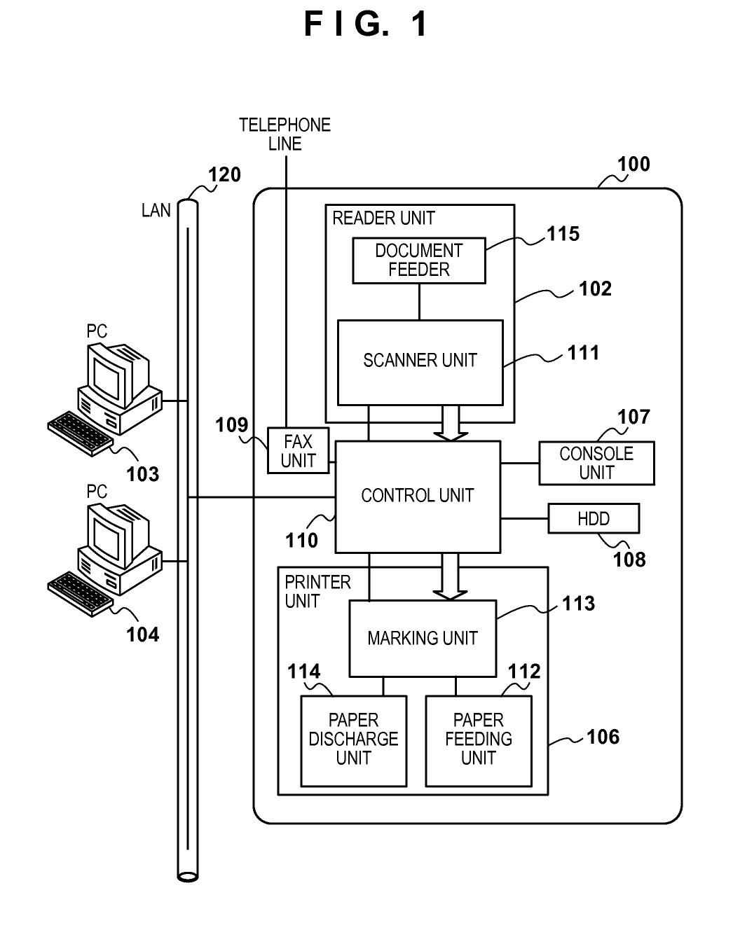

FIG. 1 is a block diagram for describing the configuration of a multi-function peripheral (MFP) according to an embodiment of the present invention.

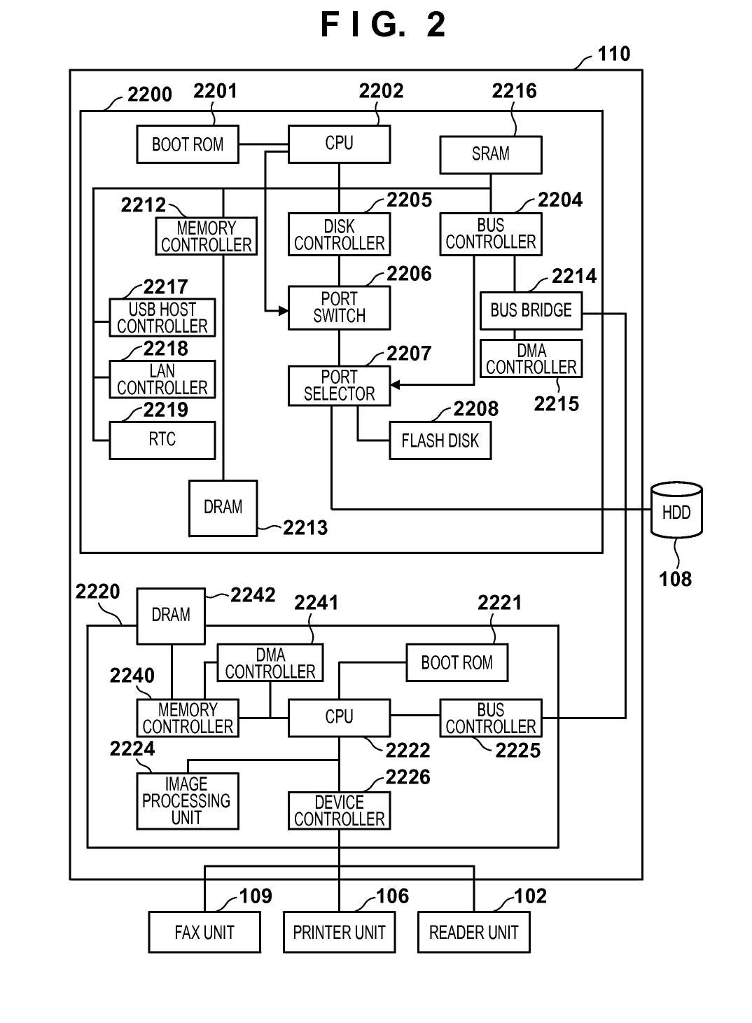

This multi-function peripheral 100 is connected to host computers (PCs) 103, 104 via a LAN (Local Area Network) 120 such as an Ethernet (registered trademark) LAN. The multi-function peripheral 100 has a reader unit 102 which reads a document and generates image data of the document, and a printer unit 106 which performs printing based on image data. A console unit 107 is provided with a keyboard for inputting instruction information and the like by a user, and a display unit which displays image data and various functions. A hard disk drive (HDD) 108 stores control programs, image data and the like. A FAX unit 109 transmits and receives facsimile signals. A control unit 110 has the configuration described later with reference to FIG. 2, and is connected to the units described above and controls the operations of these units.

The reader unit 102 has a document feeder 115 which transports an original, a scanner unit 111 which optically reads an image of the original and converts it to image data expressed by an electrical signal. The printer unit 106 has a paper feeding unit 112 that includes multiple paper cassettes which accommodate paper sheets, and a marking unit 113 which transfers and fixes an image onto a paper sheet based on image data. The printer unit 106 further has a paper discharge unit 114 which subjects the printed paper sheet to sorting processes and stapling processes and discharges the paper sheet to the outside.

FIG. 2 is a block diagram for describing the configuration of the control unit 110 according to this embodiment. It should be noted that in FIG. 2, parts which are common to those in FIG. 1 are denoted by the same numerals, and their explanation will be omitted.

The control unit 110 includes roughly two units: a main CPU unit 2200 (main board) which handles generic information processes; and a sub CPU unit 2220 (sub board) which handles image formation processes and the like. It goes without saying that it is possible to configure the main CPU unit and sub CPU unit as a single board, but in order to simplify the explanation, in this embodiment, the case where the control unit 110 has both the main CPU unit 2200 and sub CPU unit 2220 will be described below as an example. The main CPU unit 2200 includes a boot ROM 2201 which is a non-volatile memory storing a startup program, and a CPU 2202 which is an arithmetic unit which executes a startup program and other programs. Furthermore, the main CPU unit 2200 includes a DRAM 2213 which is a volatile memory that temporarily stores programs and data, and a memory controller 2212 which controls memories. An SRAM 2216 stores various data in a non-volatile manner under control of the CPU 2202.

Additionally, a bus controller 2204 which handles the connection with the sub board 2220, a disk controller 2205 which controls the hard disk 108 and the like are also mounted. Moreover, a port selector 2207 is connected to the disk controller 2205 via a port switch 2206, which switches accessibility to connected devices. A flash disk 2208 and the HDD 108 are connected to the port selector 2207, and whichever one is selected by the port selector 2207 becomes controllable from the disk controller 2205. It should be noted that in this embodiment, the disk controller 2205, the port switch 2206 and the port selector 2207 are described as modules separate from each other, but some or all of these may be mounted as a single module. Moreover, a bus bridge 2214 is mounted in order to connect the main board 2200 and the sub board 2220 via a bus, and a DMA controller 2215 which transfers data between the main board 2200 and the sub board 2220 is mounted. Moreover, various USB devices can be connected to a USB host controller 2217 via a USB connecting line. A LAN controller 2218 controls transmission and reception of data between the main board 2200 and apparatuses on the LAN 120. An RTC (Real Time Clock) 2219 notifies the CPU 2202 of an interrupt signal at a designated time, and is used for execution of time-designated jobs and the like.

Meanwhile, the sub board 2220 is provided with a boot ROM 2221 which is a non-volatile memory storing a startup program, and a CPU 2222, which is an arithmetic unit that executes the startup program and other programs. Furthermore, the sub board 2220 is provided with a volatile memory (DRAM) 2242 which temporarily stores programs and data, and a memory controller 2240 which controls memories. The sub board 2220 is further provided with a bus controller 2225 which handles the connection with the main board 2200, an image processing unit 2224 which executes image formation processes at high speed, and a device controller 2226 which controls devices such as the reader unit 102 and the printer unit 106. The device controller 2226 executes control of the FAX unit 109, the printer unit 106, the reader unit 102 and the like. In addition, a DMA controller 2241 which transfers data between the main board 2200 and the sub board 2220 is mounted.

A control program of the multi-function peripheral 100 according to this embodiment is stored in the HDD 108, developed in the DRAM 2213 by executing a boot program of the boot ROM 2201, and is executed under control of the CPU 2202. The control program according to this embodiment is executed in this form.

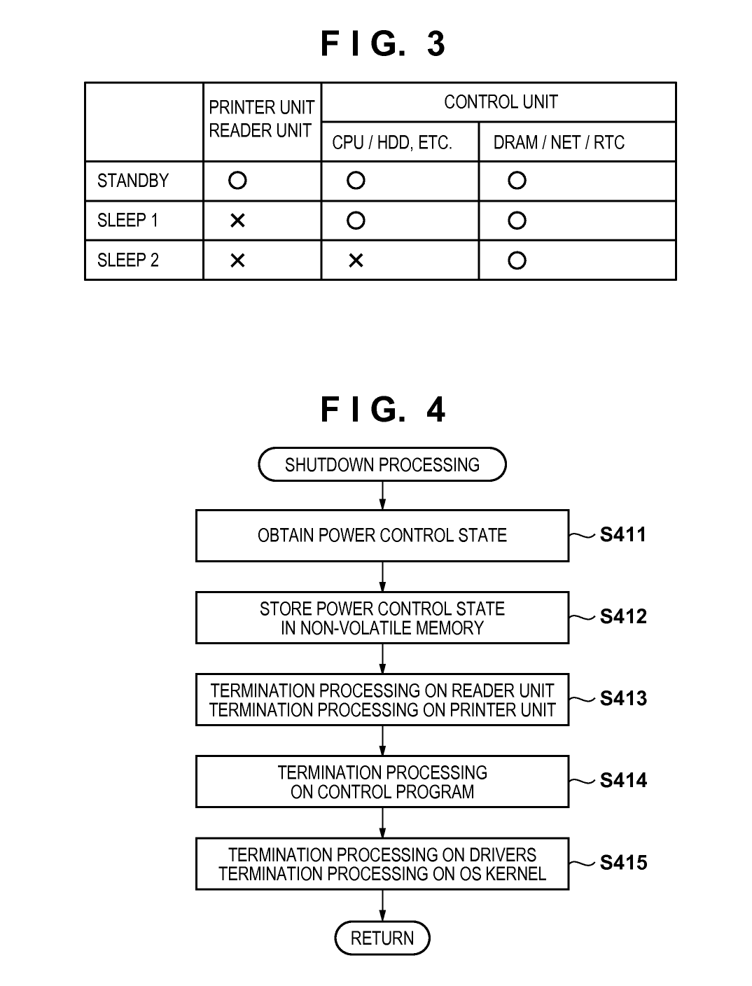

FIG. 3 depicts a view illustrating power control states of the multi-function peripheral according to this embodiment.

In this embodiment, it is assumed that the multi-function peripheral 100 has three stages of power control states: standby, sleep 1 (power saving state), and sleep 2 (power saving state). The standby state refers to the state in which electric power is supplied to all units of the multi-function peripheral 100, and the execution of jobs such as copying and printing, and FAX sending and receiving is immediately possible. The sleep 1 state refers to the state in which electric power is supplied only to the control unit 110 in the multi-function peripheral 100, during which power consumption is reduced. In this state, since the control program is in operation, internal processing of the control unit 110 is possible, but in order to execute copying, printing and other jobs, it is necessary to execute the jobs after supplying electric power to the units which have not been supplied with electric power to attain the standby state. The sleep 2 state refers to the state in which all units other than the memory controller 2212, the DRAM 2213, the LAN controller 2218, and the RTC 2219 of the control unit 110 are not supplied with electric power. In this sleep 2 state, power consumption is lower than in the sleep 1 state. Moreover, in order to execute copying, printing and other jobs in the sleep 2 state, it is necessary to temporarily supply electric power to the units which have not been supplied with electric power to reach the standby state and then execute the jobs.

FIG. 4 is a flowchart for describing shutdown processing in the multi-function peripheral 100 according to this embodiment. It should be noted that the control program which executes this processing is developed to the DRAM 2213 at the time of execution, and is executed under control of the CPU 2202.

First, in step S411, before starting the shutdown processing, the CPU 2202 obtains the current power control state of the multi-function peripheral 100, and in step S412, this power control state is stored in the SRAM 2216, which is a non-volatile memory, or the HDD 108. Next, the processing proceeds to step S413, where the CPU 2202 performs termination processing on the reader unit 102 and the printer unit 106. The processing then proceeds to step S414, where the CPU 2202 performs the termination processing on the control program, and finally in step S415, the termination processing is performed on drivers and the OS kernel.

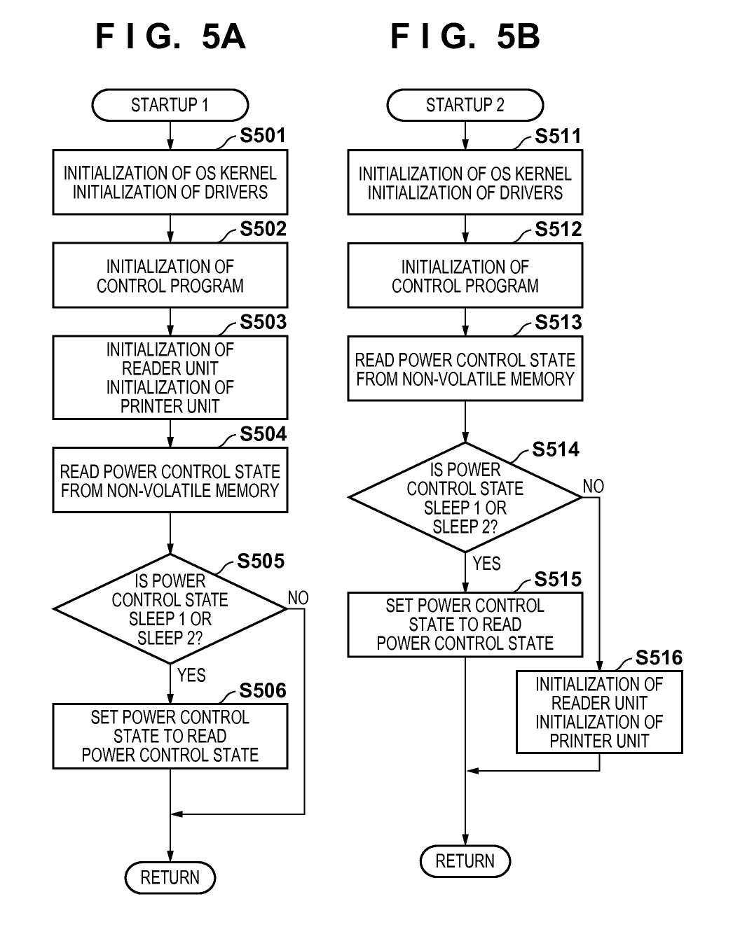

FIGS. 5A and 5B are flowcharts for describing the processing performed on startup in the multi-function peripheral 100 according to this embodiment. It should be noted that the control program which executes this processing is developed in the DRAM 2213 at the time of execution, and is executed under control of the CPU 2202.

FIG. 5A is a flowchart for describing the processing 1 performed on startup.

First, in step S501, the CPU 2202 initializes the OS kernel and drivers, and then the processing proceeds to step S502, where the control program is initialized. Next, the processing proceeds to step S503, where the CPU 2202 performs the initialization processing on the reader unit 102 and printer unit 106 so that the multi-function peripheral 100 becomes in the standby state. The processing then proceeds to step S504, where the CPU 2202 reads the power control state before the startup which is stored in the SRAM 2216, which is a non-volatile memory, or the HDD 108. Then, in step S505, it is determined whether the power control state on the shutdown processing was the sleep 1 state or the sleep 2 state shown in FIG. 3. Herein, when it is the sleep 1 or sleep 2 state, the processing proceeds to step S506, and power supply to units of the apparatus is shut off so that power control state is achieved, attaining the sleep 1 or sleep 2 state. When the power control state read in step S504 is neither sleep 1 nor sleep 2, it is left in the standby state without any processing and the processing is terminated.

In this startup processing 1, in step S503, the multi-function peripheral 100 is put in the standby state, and then if the state immediately before the shutdown was the sleep 1 state, the state is returned to the sleep 1 state in step S506. On the other hand, if the state immediately before the shutdown was the sleep 2 state, the state is returned to the sleep 2 state in step S506.

FIG. 5B is a flowchart for describing the processing 2 performed on startup.

First, in step S511, the CPU 2202 initializes the OS kernel and drivers, and initializes the control program in step S512. The processing then proceeds to step S513, where the CPU 2202 reads the power control state before the startup which is stored in the SRAM 2216, which is a non-volatile memory, or the HDD 108, and in step S514, determines whether the power control state on the shutdown processing was the sleep 1 state or the sleep 2 state shown in FIG. 3. Herein, when it is in the sleep 1 or sleep 2 state, the processing proceeds to step S515, where the CPU 2202 supplies electric power and shuts off power supply to corresponding units so that power control state is attained. Meanwhile, in step S514, when the state read in step S513 is neither sleep 1 nor sleep 2, the processing proceeds to step S516, where the CPU 2202 performs the initialization processing on the reader unit 102 and the printer unit 106 and proceeds to the standby state.

In this startup processing 2, unlike in the startup processing 1, the multi-function peripheral 100 is not put in the standby state after the initialization of the control program in step S512, and in step S514, if the state immediately before the shutdown was the sleep 1 or sleep 2 state, the multi-function peripheral 100 is put in the sleep 1 or sleep 2 state in step S515. If not, on the other hand, the multi-function peripheral 100 is put in the standby state in step S516.

The difference between these processes lies in that in FIG. 5A, the multi-function peripheral 100 is temporarily put in the standby state upon startup, while in FIG. 5B after the power control state before the shutdown is checked, and only when it is not a sleep state, the multi-function peripheral 100 is put in the standby state. Therefore, the startup processing 2 can achieve lower power consumption.

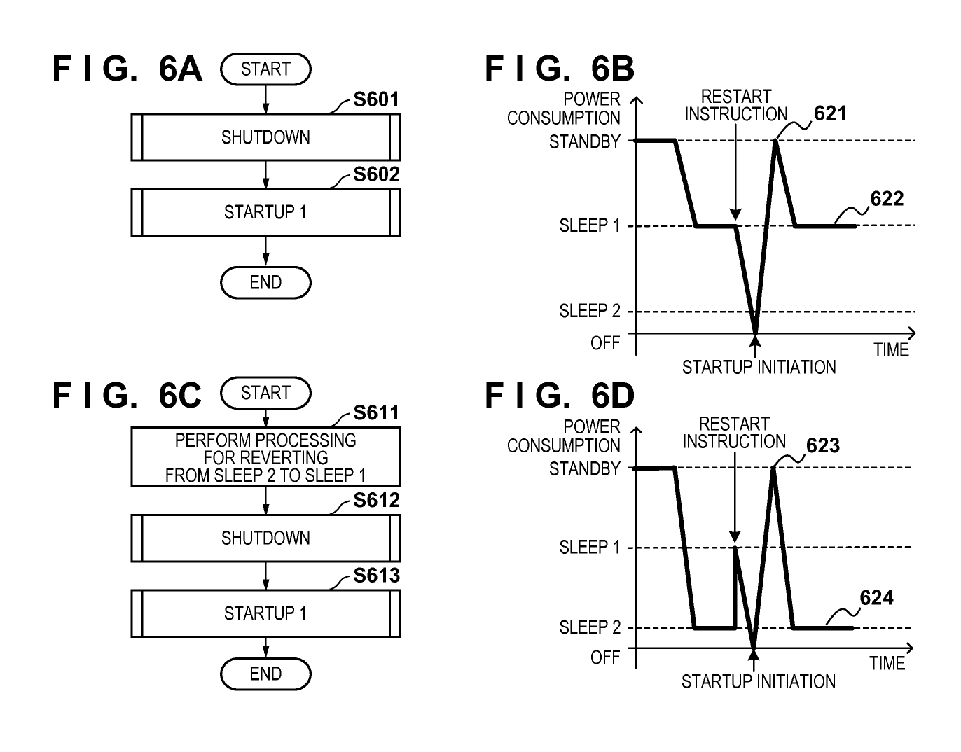

FIG. 6A is a flowchart for describing the processing when restarting (starting after the shutdown) is instructed in the sleep 1 state. Moreover, FIG. 6B depicts a graph for schematically illustrating the changes in the power consumption in this case. It should be noted that the startup processing in FIGS. 6A to 6D is the startup processing 1 shown in the flowchart of the aforementioned FIG. 5A.

In FIG. 6A, firstly in step S601, if restarting is instructed when the multi-function peripheral 100 is in the sleep 1 state, the CPU 2202 first performs the shutdown processing according to the flowchart of FIG. 4. When this shutdown ends, the power consumption is in the OFF state in FIG. 6B. Next, in step S602, startup is initiated, and the CPU 2202 performs the startup processing 1 according to the flowchart of FIG. 5A. In this case, the power control state after the completion of the initialization processing on the reader unit 102 and the printer unit 106 of step S503 in FIG. 5A is the standby state as shown by 621 in FIG. 6B. The power control state after the processing is completed in step S506 is, as shown by 622 in FIG. 6B, in the sleep 1 state.

FIG. 6C is a flowchart for describing the processing performed when restarting is instructed in the sleep 2 state. Moreover, FIG. 6D depicts a graph for schematically illustrating the changes of the power consumption in this case.

If restarting is instructed when the multi-function peripheral 100 is in the sleep 2 state, firstly, in step S611, the multi-function peripheral 100 temporarily proceeds to the sleep 1 state so that the control program can be operated. Supposing that it is a time-designated shutdown, the RTC 2219 sends a sleep reversion signal to the CPU 2202, and the CPU 2202 operates the control program and controls the control unit 110 to transition to the sleep 1 state. The power control state after the completion of step S611 changes from the sleep 2 state to sleep 1 in FIG. 6D. Next, the processing proceeds to step S612, where the CPU 2202 performs the shutdown processing according to the flowchart of FIG. 4. At the completion of this shutdown processing, the power consumption is in the OFF state in FIG. 6D. When startup is initiated next, the processing proceeds to step S613, where the CPU 2202 performs the startup processing 1 according to the flowchart of FIG. 5A. The power control state after the completion of step S503 in FIG. 5A is the standby state as shown by 623 in FIG. 6D, and the power control state after the completion of step S506 is the sleep 2 state shown by 624 in FIG. 6D.

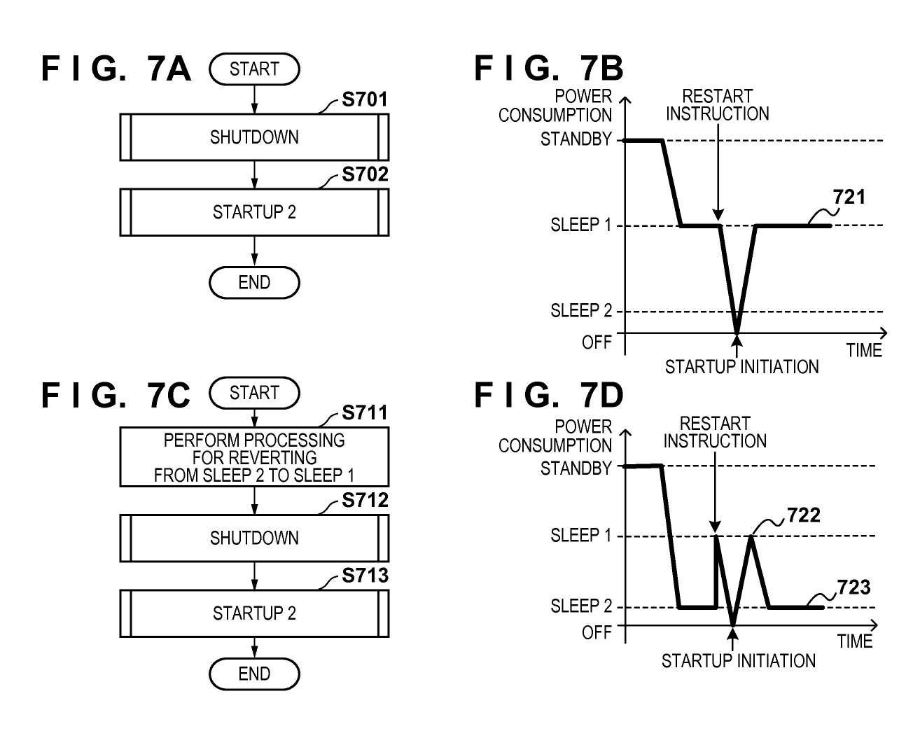

FIG. 7A is a flowchart for describing the processing performed when restarting is instructed in the sleep 1 state. Moreover, FIG. 7B depicts a graph for schematically illustrating the changes of the power consumption in this case. It should be noted that the startup processing in FIGS. 7A to 7D is the startup processing 2 shown in the flowchart of the aforementioned FIG. 5B.

In step S701 in FIG. 7A, when restarting is instructed in the sleep 1 state, the CPU 2202 first performs the shutdown processing according to the flowchart of FIG. 4. At the completion of this shutdown processing, power consumption is in the OFF state in FIG. 7B. When startup is initiated next, the processing proceeds to step S702, where the CPU 2202 performs the startup processing 2 according to the flowchart of FIG. 5B. Herein the power control state after the completion of at step S515 is, as shown by 721 of FIG. 7B, in the sleep 1 state.

FIG. 7C is a flowchart for describing the processing performed when restarting is instructed in the sleep 2 state. Moreover, FIG. 7D depicts a graph for schematically illustrating the changes of the power consumption in this case.

If restarting is instructed when the multi-function peripheral 100 is in the sleep 2 state, firstly, in step S711, the multi-function peripheral 100 temporarily transitions from the sleep 2 state to sleep 1 so that the control program can be operated. Supposing that it is a time-designated shutdown, the RTC 2219 sends a sleep reversion signal to the CPU 2202, and the CPU 2202 operates the control program and controls the control unit 110 to transition to the sleep 1 state. The power control state after the completion of the processing in this step S711 is the sleep 1 state in FIG. 7D. When shutdown is instructed next, the processing proceeds to step S712, and the CPU 2202 performs shutdown according to the flowchart in FIG. 4. At the completion of this shutdown processing, power consumption is in the OFF state in FIG. 7D. Then in step S713, when startup is initiated, the CPU 2202 performs the startup processing 2 according to the flowchart of FIG. 5B. The power control state after the completion of step S512 is the sleep 1 state shown by 722 in FIG. 7D, and the power control state after the completion of step S515 is the sleep 2 state as shown by 723 in FIG. 7D.

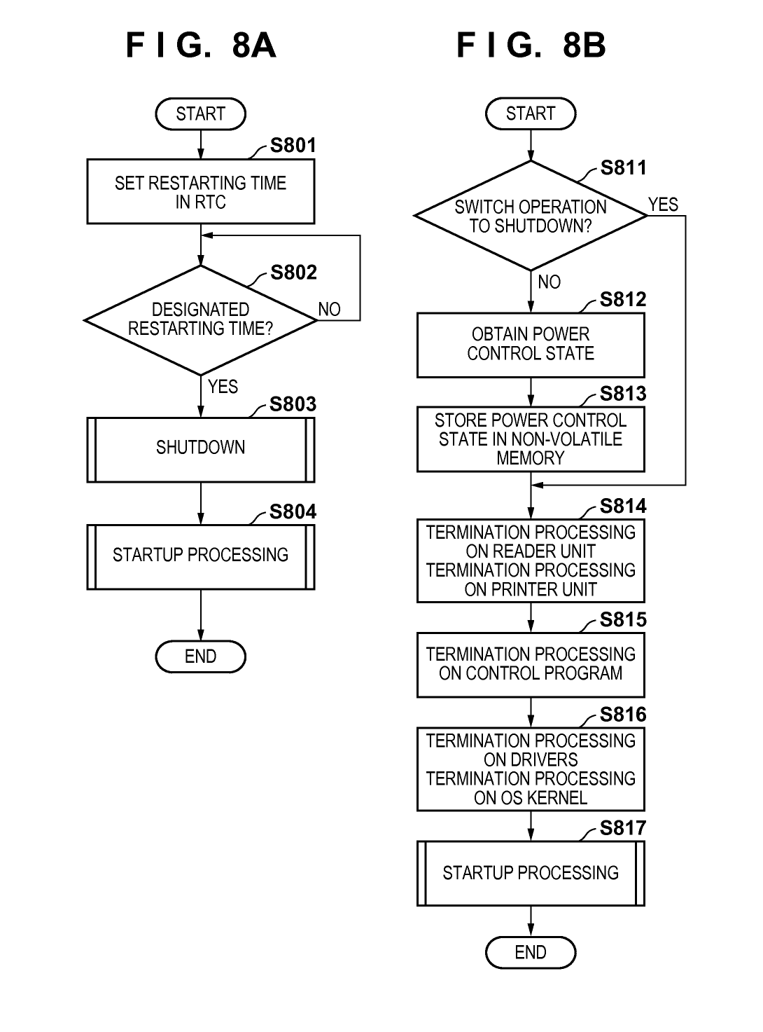

FIG. 8A is, in the multi-function peripheral according to this embodiment, a flowchart for describing the processing performed when restarting is initiated at a designated time. It should be noted that the control program which executes this processing is developed in the DRAM 2213 at the time of execution, and is executed under control of the CPU 2202.

When restarting is performed at a designated time, the user sets a time via the console unit 107. Accordingly, in step S801, the CPU 2202 sets the time in RTC 2219. Next in step S802, when the set time is reached, the RTC 2219 notifies the CPU 2202 that it is now the designated time. Accordingly, the processing proceeds to step S803, and the CPU 2202 performs the shutdown processing according to the flowchart in FIG. 4. Next, the processing proceeds to step S804, where the startup processing is performed according to the flowchart in FIG. 5A or FIG. 5B, and the multi-function peripheral 100 is put in the power control state that had been attained immediately before the restarting was instructed.

FIG. 8B is a flowchart for describing the processing performed when restarting is instructed by the operation of a switch by the user. It should be noted that the control program which executes this processing is developed in the DRAM 2213 at the time of execution, and is executed under control of the CPU 2202.

Firstly, in step S811, it is determined whether the power switch of the multi-function peripheral 100 has been operated. When there has been no operation of the switch, the processing proceeds to step S812, where the CPU 2202 obtains the current power control state in the multi-function peripheral 100, and in step S813, the CPU 2202 stores this state in the SRAM 2216, which is a non-volatile memory, or the HDD 108. Next, the processing proceeds to step S814, where the CPU 2202 performs termination processing on the reader unit 102 and the printer unit 106, and in step S815, the CPU 2202 performs the termination processing on the control program. The processing then proceeds to step S816, where the termination processing is performed on the OS kernel. The termination processing in these steps S814 to S816 is the same as the shutdown processing at steps S413 to S415 in FIG. 4. Meanwhile, when there has been an operation of the power switch in step S811, the processing proceeds to step S814 without storing the power control state or the like, and the shutdown processing is executed.

Next, the startup processing is initiated in step S817, and the CPU 2202 performs the startup processing 1 in FIG. 5A or the startup processing 2 in FIG. 5B. Thus, when there has been no operation of the power switch by the user, the multi-function peripheral 100 returns to the power control state that had been attained immediately before the restarting was instructed, while when there has been an operation of the power switch by the user, the multi-function peripheral 100 transitions to the standby state after restarting.

Accordingly, when the user feels some sort of inconvenience and restarts the multi-function peripheral 100, all units are initialized with no exception regardless of the power control state before the restarting, and put in the standby state.

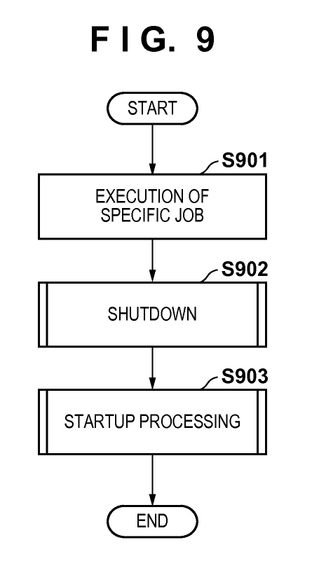

FIG. 9 is a flowchart for describing the processing performed when restarting is performed at the end of a specific job. It should be noted that the control program which executes this processing is developed in the DRAM 2213 at the time of execution, and is executed under control of the CPU 2202.

For example, in the case of jobs for updating the setting values and programs of the multi-function peripheral 100, the CPU 2202 downloads new update files in step S901. Then in step S902, the shutdown processing in FIG. 4 is performed to restart for updating. The processing then proceeds to step S903, where the startup processing of FIG. 5A or FIG. 5B is performed.

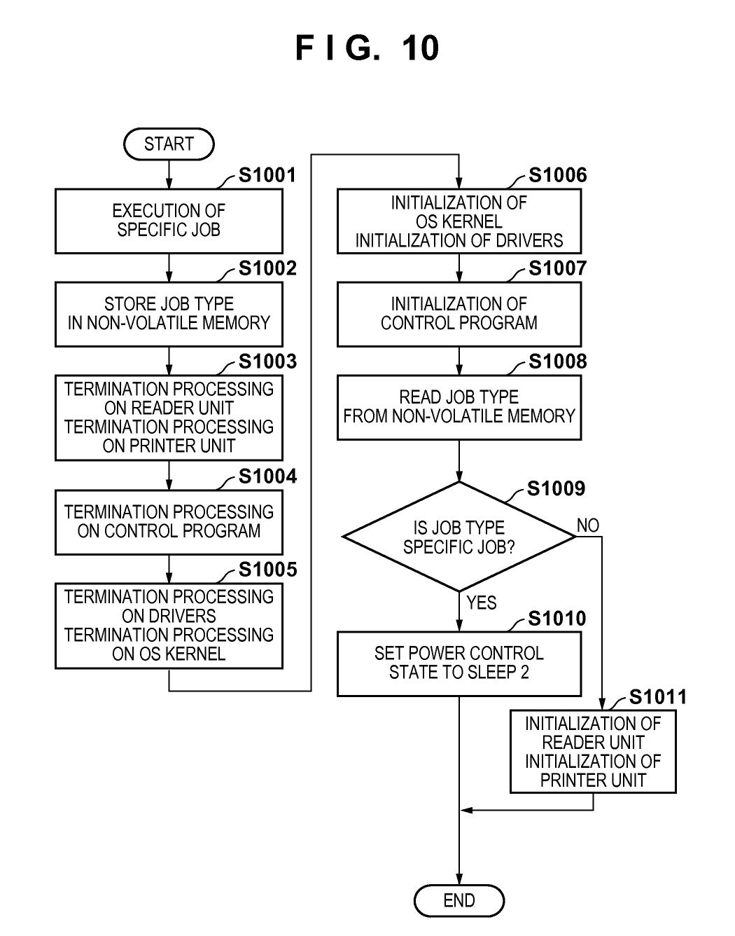

FIG. 10 is a flowchart for describing processing performed by a restart instruction after the specific job has been executed. It should be noted that the control program which executes this processing is developed in the DRAM 2213 at the time of execution, and is executed under control of the CPU 2202.

For example, in the case of specific jobs for updating the setting values and programs of the multi-function peripheral 100, the CPU 2202 downloads new update files in step S1001. The processing then proceeds to step S1002, where the CPU 2202 stores this job type in the SRAM 2216, which is a non-volatile memory, or the HDD 108. Next, the processing proceeds to step S1003, where the CPU 2202 performs the termination processing on the reader unit 102 and the printer unit 106, and in step S1004, the CPU 2202 performs the termination processing on the control program. Finally, the processing proceeds to step S1005, where the CPU 2202 performs the termination processing on drivers and the OS kernel. The termination processing of these steps S1003 to S1005 is the same as the shutdown processing in steps S413 to S415 in FIG. 4.

When startup is initiated next, the processing proceeds to step S1006, where the CPU 2202 performs initialization of drivers and the OS kernel. The processing then proceeds to step S1007, where the CPU 2202 initializes the control programs and performs updating using the downloaded files. Next, the processing proceeds to step S1008, where the CPU 2202 reads the job type stored in the SRAM 2216, which is a non-volatile memory, or the HDD 108. The processing then proceeds to step S1009, where the CPU 2202 determines whether or not the job type is the specific job. Herein, when it is determined that the job type is a predetermined specific job type, the processing proceeds to step S1010, where the CPU 2202 forcibly puts the power control state of the multi-function peripheral 100 in the power saving state (sleep 2). On the other hand, when it is determined in step S1009 that the job type is not the specific job type, the processing proceeds to step S1011, where the CPU 2202 performs the initialization processing on the reader unit 102 and printer unit 106 to put the multi-function peripheral 100 in the standby state.

Accordingly, regardless of the power control state before restarting is instructed, in the case of restarting during the execution of the specific job, the power control state is always controlled to be in the power saving state on the restarting.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-235308 filed Oct. 26, 2011, which is hereby incorporated by reference herein in its entirety.

What is claimed is:

1. An electric apparatus provided with a power saving function, comprising:
a storage unit configured to, when restarting is instructed, store in a non-volatile manner the power control state of the electric apparatus before shutdown processing is started;
a reading unit configured to read the power control state stored in the storage unit after the restarting is initiated after completion of the shutdown processing;
a first transition unit configured to, when the power control state read by the reading unit is a power saving state, transition the electric apparatus to the power saving state; and
a second transition unit that, when the power control state read by the reading unit is not the power saving state, or when the power control state is not stored in the storage unit, transition the electric apparatus to a standby state.

2. The electric apparatus according to claim 1, further comprising an instruction unit configured to instruct restarting at a set time.

3. The electric apparatus according to claim 1, further comprising a determination unit configured to determine whether or not the restarting was instructed by an operation by a user,
wherein the storage unit stores, when the determination unit determines that the restarting was not instructed by an operation by a user, the power control state of the electric apparatus prior to initiation of the shutdown processing.

4. The electric apparatus according to claim 1, further comprising a judgment unit configured to judge whether or not the restarting was instructed by execution of a specific job,
wherein the storage unit stores, when the judgment unit judges that the restarting was instructed by execution of the specific job, the power control state of the electric apparatus prior to initiation of the shutdown processing.

5. The electric apparatus according to claim 1, further comprising:
a determination unit configured to determine whether or not the restarting was instructed by an operation by a user; and
a control unit configured to, when the determination unit determines that the restarting was instructed by an operation by a user, perform control such that the power control state of the electric apparatus is not stored in the storage unit.

6. The electric apparatus according to claim 1,
wherein the electric apparatus is a multi-function peripheral, and
the power saving state includes a first power saving state in which power supply to a printer unit and a scanner unit is shut off, and a second power saving state in which power supply to a CPU in addition to the printer unit and the scanner unit is shut off.

7. A method for controlling power of an electric apparatus provided with a power saving function, the method comprising:
a step of obtaining, when restarting is instructed, the power control state of the electric apparatus and storing the power control state in a non-volatile memory before shutdown processing is started;
a reading step of reading the power control state stored in the non-volatile memory after the restarting is initiated after completion of the shutdown processing;
a transition step of, when the power control state read in the reading step is a power saving state, transitioning the electric apparatus to the power saving state; and
a step of, when the power control state read in the reading step is not the power saving state, or when the power control state is not stored in the non-volatile memory, transitioning the electric apparatus to a standby state.

8. The method according to claim 7, further comprising an instruction step of instructing restarting at a set time.

9. The method according to claim 7, further comprising a determination step of determining whether or not the restarting was instructed by an operation by a user,
wherein in the storage step, when it is determined in the determination step that the restarting was not instructed by an operation by a user, the power control state of the electric apparatus is stored prior to initiation of the shutdown processing.

10. The method according to claim 7, further comprising a judgment step of judging whether or not the restarting was instructed by execution of a specific job,
wherein in the storage step, when it is judged that the restarting was instructed by execution of the specific job in the judgment step, the power control state of the electric apparatus is stored prior to initiation of the shutdown processing.

11. The method according to claim 7, further comprising:
a determination step of determining whether or not the restarting was instructed by an operation by a user; and
a control step of, when it is determined that the restarting was instructed by an operation by a user in the determination step, performing control such that the power control state of the electric apparatus is not stored in the storage step.
